(19) United States
(12) Patent Application Publication
(10) Pub. No.: US 2021/0091964 A1
(43) Pub. Date: Mar. 25, 2021

(54) PHYSICALLY UNCLONABLE STRUCTURAL-COLOR ANTI-COUNTERFEITING LABEL WITH ARTIFICIAL INTELLIGENCE AUTHENTICATION

(71) Applicant: Hebei Normal University, Shijiazhuang (CN)

(72) Inventors: Jinming Zhou, Shijiazhuang (CN); Xueying He, Shijiazhuang (CN); Yanan Gu, Shijiazhuang (CN); Heling Zhu, Shijiazhuang (CN)

(21) Appl. No.: 17/000,436

(22) Filed: Aug. 24, 2020

(30) Foreign Application Priority Data
Sep. 23, 2019 (CN) 201910898916.6

(51) Int. Cl. H04L 9/32; B42D 25/405; B42D 25/373; G06N 20/00

(52) U.S. Cl. CPC H04L 9/3278; G06N 20/00; B42D 25/373; B42D 25/405

(57) ABSTRACT

The invention discloses a physically unclonable structural-color anti-counterfeiting label with artificial intelligence (AI) authentication, which is formed by doping micron-sized particles into disorderedly arranged monodisperse submicron-sized particles and coating onto a black substrate; alternatively, by doping micron-sized particles and black nanoparticles into disorderedly arranged monodisperse submicron-sized particles and coating onto a substrate. The disordered arrangement of monodisperse submicron-sized microspheres has a special effect on light to make the anti-counterfeiting label show a specific structural color. AI is used to learn the anti-counterfeiting label images obtained from an optical microscope and memorize their structural characteristics to form an anti-counterfeiting label database. The optical microscope images of the anti-counterfeiting labels taken by end users or in any circulation links are sent to the database to compare with structural characteristics in the database, and a similarity value is fed back by AI to realize the function of anti-counterfeiting and authenticity verification.

### TECHNICAL FIELD

The invention relates to an anti-counterfeiting label based on structural colors, in particular to a physically unclonable structural-color anti-counterfeiting label with artificial intelligence (AI) authentication, belonging to the technical field of anti-counterfeiting materials and structural-color materials.

### BACKGROUND

Forged products bring about significant financial losses every year and poses severe security threats to individuals, companies, and society as a whole. Currently, although most commodities have been protected by various advanced anti-counterfeiting measures, such as fluorescent techniques, thermochromic techniques, plasma optical techniques, watermarks and holographic patterns, etc., the global financial losses due to counterfeiting are still increasing at an annual growth rate of 11.7%. This is primarily due to the fact that most of the anti-counterfeiting strategies being used today, which have a fixed and predictable anti-counterfeiting mechanism, can be copied by counterfeiters. Physically unclonable anti-counterfeiting techniques based on random structure, such as artificial fingerprints (H. J. Bae, S. Bae, C. Park, S. Han, J. Kim, L. N. Kim, K. Kim, S. H. Song, W. Park, S. Kwon, Adv. Mater. 2015, 27, 2083), unique surface structure (J. D. Buchanan, R. P. Cowburn, A. V. Jausovec, D. Petit, P. Seem, G. Xiong, D. Atkinson, K. Fenton, D. A. Allwood, M. T. Bryan, Nature 2005, 436, 475) or random arrangement of nanoparticles (Y. Zheng, C. Jiang, S. H. Ng, Y. Lu, F. Han, U. Bach, J. J. Gooding, Adv. Mater. 2016, 28, 2330), may provide an ideal anti-counterfeiting solution. At present, although the encryption of physically unclonable functions through various non-deterministic processes has made great progress, the identification of physically unclonable structures still requires a special digitizing process to generate keys or machine learning for point-to-point image recognition. Such identification techniques have disadvantages of taking long time and high error rates (R. Arppe, T. J. Sorensen, Nat. Rev. Chem. 2017, 1, 0031). Recently, a physically unclonable flower-like fluorescent anti-counterfeiting techniques based on quantum dots has been reported in the literature, where AI-based authentication strategy is developed for the fast and high-precision authentication of patterns. However, the toxicity of quantum dots and the property of being prone to photobleaching seriously limit the wide practical application of the anti-counterfeiting techniques.

Compared with fluorescence, the structural colors caused by sub-micron scale special physical structure shows the property of never fading and more environment-friendly. However, the currently common structural-color anti-counterfeiting labels are mainly based on the iridescent colors caused by the long-range ordered structure or the responsiveness caused by external field stimuli (S. L. Wu, B. Q. Liu, X. Su, S. F. Zhang, J. Phys. Chem. Lett. 2017, 8, 2835; Y Heo, H. Kang, J. S. Lee, Y K. Oh, S. H. Kim, Small 2016, 12, 3819; W. Fan, J. Zeng, Q. Q. Gan, D. X. Ji, H. M. Song, W. Z. Liu, L. Shi, L. M. Wu, Sci. Adv. 2019, 5, eaaw8755; R. Y Xuan, J. P. Ge, J. Mater. Chem. 2012, 22, 367; K. Zhong, J. Li, L. Liu, S. Van Cleuvenbergen, K. Song, K. Clays, Adv. Mater. 2018, 30, e1707246). The long-range ordered structure also has the risk of being easily cloned and counterfeited, which greatly reduces the anti-counterfeiting security. In contrast, disordered optical structures that cause non-iridescent structural colors (J. M. Zhou, P. Han, M. J. Liu, H. Y. Zhou, Y X. Zhang, J. K. Jiang, P. Liu, Y. Wei, Y L. Song, X. Yao, Angew. Chem. Int. Ed. 2017, 56, 10462; Y. Takeoka, S. Yoshioka, A. Takano, S. Arai, K. Nueangnoraj, H. Nishihara, M. Teshima, Y. Ohtsuka, T. Seki, Angew. Chem. Int. Ed. 2013, 52, 7261; Y X. Zhang, P. Han, H. Y. Zhou, N. Wu, Y Wei, X. Yao, J. M. Zhou, Y L. Song, Adv. Funct. Mater. 2018, 28, 1802585.) have special physically unclonable properties, but the lack of efficient structural recognition techniques severely limits the practical application of such materials in the field of anti-counterfeiting.

### SUMMARY

The invention aims to provide a physically unclonable structural-color anti-counterfeiting label with artificial intelligence (AI) authentication.

The invention also aims to provide a method for verifying a physically unclonable structural-color anti-counterfeiting label with AI authentication.

The structure of the structural-color anti-counterfeiting label is formed by randomly doping micron-sized microspheres into disorderedly arranged monodisperse submicron-sized microspheres and coating onto a black substrate to form a pattern; alternatively, randomly doping micron-sized microspheres and black nanoparticles into monodisperse submicron-sized microspheres and coating onto a substrate to form a pattern.

The micron-sized microspheres are polymer microspheres, metal oxide microspheres, carbon spheres and the like, and are preferably selected from one or a mixture of two or more of polystyrene microspheres, starch microspheres, albumin microspheres, gelatin microspheres, chitosan microspheres, silica microspheres, alumina microspheres, zinc oxide microspheres, ferroferric oxide microspheres, manganese dioxide microspheres and titanium dioxide microspheres, with a size ranging from 1 μm to 50 μm.

Surfaces of the micron-sized microspheres are wrapped or partially covered with monodisperse submicron-sized particles.

The monodisperse submicron-sized microspheres are polymer colloidal microspheres, metal oxide colloidal microspheres, metal sulfides, metal colloidal microspheres, elementary substance colloidal microspheres and the like, and are preferably selected from one of styrene colloidal microspheres, polymethyl methacrylate colloidal microspheres, polystyrene-polymethyl methacrylate-polyacrylic acid colloidal microspheres, silica colloidal microspheres, titanium dioxide colloidal microspheres, ferric sulfide colloidal microspheres, gold colloidal microspheres, ferroferric oxide colloidal microspheres, copper oxide colloidal microspheres, sulfur colloidal microsphere, gold colloidal microspheres and silver colloidal microspheres, with a size ranging from 120 nm to 1000 nm.

The black nanoparticles are carbon black nanoparticles, ferroferric oxide nanoparticles, dopamine nanoparticles, melanin nanoparticles, graphene nanosheets, carbon nanotubes, metal particles and the like, with a size ranging from 5 nm to 100 nm, and a mass fraction accounting for 0.1%-2% of the monodisperse submicron microspheres.

A mass fraction of the micron-sized microspheres accounts for 5%-50% of the monodisperse submicron microspheres.

A spectral range corresponding to the structural colors ranges from 390 nm to 800 nm, covering the whole visible light region.

A method for verifying the anti-counterfeiting label includes the steps that characteristics of disordered optical structures in images from optical microscopes are learned and memorized by AI to form a genuine product database; structures captured by the optical microscopes in a commodity circulation link are transmitted to the AI database and authenticated by AI, and the authenticity is verified according to the similarity.

The beneficial effects achieved by the present invention are as follows: combined with AI, the disordered optical structure is authenticated effectively by deep learning, realizing a physically unclonable anti-counterfeiting label. The anti-counterfeiting label has the characteristics of environmental friendliness, compatibility with the existing packaging approach and easiness in large-scale fabrication, and has important application value in the anti-counterfeiting aspects of confidential files, currency, medicines and other commodities with high added value.

### BRIEF DESCRIPTION OF THE DRAWING

FIG. 1 shows physically unclonable anti-counterfeiting label with butterfly, numbers, alphabets, barcode patterns in Examples 1, 2, 3, 4 of the present invention.

FIG. 2 shows an image of the physically unclonable anti-counterfeiting label from an optical microscope in Example 1 of the present invention. The anti-counterfeiting label has green structural colors, with irregularly and randomly arranged micron-sized particles enabling the structural-color anti-counterfeiting label to have a physically unclonable function (PFU).

FIG. 3 shows a reflection spectrum of the anti-counterfeiting label in Examples 1, 2, 3, 4 and 5 of the present invention.

### DETAILED DESCRIPTION

### Example 1

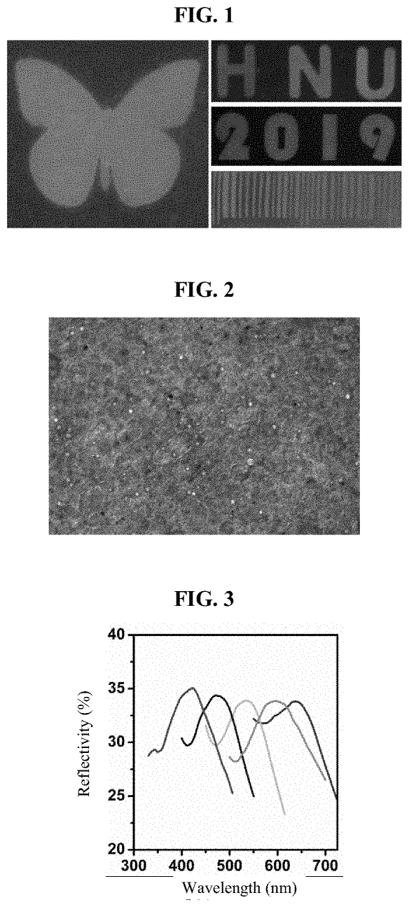

To an emulsion containing monodisperse polystyrene-polymethyl methacrylate-polyacrylic acid colloidal microspheres with a particle size of 210 nm and a mass fraction of 10%, was added silica microspheres with a mass fraction accounting for 20% of the monodisperse microspheres and a particle size of 10 μm, ultrasonic dispersion was carried out, the emulsion was sprayed onto a black substrate and dried to obtain a non-iridescent structure colors anti-counterfeiting label with a butterfly-pattern, which consisted of disordered optical structure (FIG. 1). An image of the anti-counterfeiting label from an optical microscope shown in FIG. 2 was green, with the silica microspheres distributed in the anti-counterfeiting label in a disordered and random manner. A reflection spectrum of the anti-counterfeiting label had a reflection peak at 530 nm (FIG. 3). Images from the optical microscope were input into AI for learning and memorizing characteristics to form a database, the images from the optical microscope after changing the shooting environment were input into the database, and the result was judged to be true when a similarity value of the system was greater than 0.99.

### Example 2

To an emulsion containing monodisperse styrene colloidal microspheres with a particle size of 150 nm and a mass fraction of 10%, was added gelatin microspheres with a mass fraction accounting for 50% of the monodisperse microspheres and a particle size of 50 μm, ultrasonic dispersion was carried out, the emulsion was sprayed onto a black substrate and dried to obtain a non-iridescent structure colors anti-counterfeiting label with a alphabets-pattern, which consisted of disordered optical structure (FIG. 1). The anti-counterfeiting label was purple, with the gelatin microspheres distributed in the anti-counterfeiting label in a disordered and random manner. A reflection spectrum of the anti-counterfeiting label had a reflection peak at 450 nm (FIG. 3). Images from the optical microscope were input into AI for learning and memorizing characteristics to form a database, the images from the optical microscope after changing the shooting environment were input into the database, and the result was judged to be true when a similarity value of the system was greater than 0.99.

### Example 3

To an emulsion containing monodisperse polystyrene microspheres with a particle size of 180 nm and a mass fraction of 20%, was added starch microspheres with a mass fraction accounting for 30% of the monodisperse microspheres and a particle size of 10 μm, ultrasonic dispersion was carried out, the emulsion was sprayed onto a black substrate and dried to obtain a non-iridescent structure colors anti-counterfeiting label with a numbers-pattern, which consisted of disordered optical structure (FIG. 1). The anti-counterfeiting label was red, with the starch microspheres distributed in the anti-counterfeiting label in a disordered and random manner. A reflection spectrum of the anti-counterfeiting label had a reflection peak at 481 nm (FIG. 3). Images from the optical microscope were input into AI for learning and memorizing characteristics to form a database, the images from the optical microscope after changing the shooting environment were input into the database, and the result was judged to be true when a similarity value of the system was greater than 0.99.

### Example 4

To an emulsion containing monodisperse polystyrene microspheres with a particle size of 250 nm and a mass fraction of 20%, was added starch microspheres with a mass fraction accounting for 30% of the monodisperse microspheres and a particle size of 1 μm, ultrasonic dispersion was carried out, the emulsion was sprayed onto a black substrate and dried to obtain a non-iridescent structure colors anti-counterfeiting label with a barcode-pattern, which consisted of disordered optical structure (FIG. 1). The anti-counterfeiting label was red, with the starch microspheres distributed in the anti-counterfeiting label in a disordered and random manner. A reflection spectrum of the anti-counterfeiting label had a reflection peak at 630 nm (FIG. 3). Images from the optical microscope were input into AI for learning and memorizing characteristics to form a database, the images of the sample not recorded in the database from the optical microscope were input into the database, and the result was judged to be false when a similarity value of the system was less than 0.1.

### Example 5

To an emulsion containing monodisperse polymethyl methacrylate microspheres with a particle size of 225 nm and a mass fraction of 20%, was added chitosan microspheres with a mass fraction accounting for 30% of the monodisperse microspheres and a particle size of 10 μm, ultrasonic dispersion was carried out, the emulsion was sprayed onto a black substrate and dried to obtain a non-iridescent structure colors anti-counterfeiting label with a barcode-pattern, which consisted of disordered optical structure. A reflection spectrum of the anti-counterfeiting label had a reflection peak at 545 nm (FIG. 3). The chitosan microspheres were distributed in the anti-counterfeiting label in a disordered and random manner.

### Example 6

To an emulsion containing monodisperse silica colloidal microspheres with a particle size of 120 nm and a mass fraction of 20%, was added alumina microspheres with a mass fraction accounting for 30% of the monodisperse microspheres and a particle size of 20 μm, ultrasonic dispersion was carried out, the emulsion was sprayed onto a black substrate and dried to obtain a non-iridescent structure colors anti-counterfeiting label with a barcode-pattern, which consisted of disordered optical structure. The anti-counterfeiting label was purple, with the alumina microspheres distributed in the anti-counterfeiting label in a disordered and random manner. A reflection spectrum of the anti-counterfeiting label had a reflection peak at 390 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 7

To an emulsion containing monodisperse gold colloidal microspheres with a particle size of 1000 nm and a mass fraction of 20%, was added zinc oxide microspheres with a mass fraction accounting for 30% of the monodisperse microspheres and a particle size of 30 μm, ultrasonic dispersion was carried out, the emulsion was sprayed onto a black substrate and dried to obtain a non-iridescent structure colors anti-counterfeiting label with a triangle-pattern, which consisted of disordered optical structure. The anti-counterfeiting label was red, with the zinc oxide microspheres distributed in the anti-counterfeiting label in a disordered and random manner. A reflection spectrum of the anti-counterfeiting label had a reflection peak at 800 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 8

To an emulsion containing monodisperse ferroferric oxide colloidal microspheres with a particle size of 250 nm and a mass fraction of 20%, was added ferroferric oxide microspheres with a mass fraction accounting for 30% of the monodisperse microspheres and a particle size of 40 μm, ultrasonic dispersion was carried out, the emulsion was sprayed onto a black substrate and dried to obtain a non-iridescent structure colors anti-counterfeiting label with a triangle-pattern, which consisted of disordered optical structure. The anti-counterfeiting label was red, with ferric oxide microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 9

To an emulsion containing monodisperse copper oxide colloidal microspheres with a particle size of 250 nm and a mass fraction of 20%, was added manganese dioxide and zinc oxide microspheres (at a mass ratio of 1:1) with a mass fraction accounting for 30% of the monodisperse microspheres and a particle size of 50 μm, ultrasonic dispersion was carried out, the emulsion was sprayed onto a black substrate and dried to obtain a non-iridescent structure colors anti-counterfeiting label with a triangle-pattern, which consisted of disordered optical structure. The anti-counterfeiting label was red, with manganese oxide microspheres and the mixed zinc oxide microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 10

To an emulsion containing monodisperse sulfur colloidal microspheres with a particle size of 250 nm and a mass fraction of 20%, was added manganese dioxide microspheres with a mass fraction accounting for 30% of the monodisperse microspheres and a particle size of 10 μm, ultrasonic dispersion was carried out, the emulsion was sprayed onto a black substrate and dried to obtain a non-iridescent structure colors anti-counterfeiting label with a triangle-pattern, which consisted of disordered optical structure. The anti-counterfeiting label was red, with manganese oxide microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 11

To an emulsion containing monodisperse titanium dioxide colloidal microspheres with a particle size of 250 nm and a mass fraction of 20%, was added manganese oxide, zinc oxide and gelatin microspheres (at a mass ratio of 1:1:1) with a mass fraction accounting for 30% of the monodisperse microspheres and a particle size of 10 μm, ultrasonic dispersion was carried out, the emulsion was sprayed onto a black substrate and dried to obtain a non-iridescent structure colors anti-counterfeiting label with a triangle-pattern, which consisted of disordered optical structure. The anti-counterfeiting label was red, with the mixed microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 12

To an emulsion containing monodisperse polystyrene colloidal microspheres with a particle size of 250 nm and a mass fraction of 20%, was added titanium dioxide microspheres (at a mass ratio of 1:1:1) with a mass fraction accounting for 5% of the monodisperse microspheres and a particle size of 10 μm, ultrasonic dispersion was carried out, the emulsion was sprayed onto a black substrate and dried to obtain a non-iridescent structure colors anti-counterfeiting label with a triangle-pattern, which consisted of disordered optical structure. The anti-counterfeiting label was red, with albumin microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 13

To an emulsion containing monodisperse polystyrene colloidal microspheres with a particle size of 250 nm and a mass fraction of 20%, was added polystyrene microspheres (at a mass ratio of 1:1:1) with a mass fraction accounting for 30% of the monodisperse microspheres and a particle size of 10 μm and carbon black nanoparticles with a mass fraction accounting for 0.1% of the monodisperse microspheres and a particle size of 5 nm, ultrasonic dispersion was carried out, the emulsion was sprayed onto a substrate and dried to obtain a non-iridescent structure colors anti-counterfeiting label with a triangle-pattern, which consisted of disordered optical structure. The anti-counterfeiting label was red, with albumin microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 14

To an emulsion containing monodisperse polystyrene colloidal microspheres with a particle size of 250 nm and a mass fraction of 20%, was added albumin microspheres (at a mass ratio of 1:1:1) with a mass fraction accounting for 30% of the monodisperse microspheres and a particle size of 10 μm and ferroferric oxide nanoparticles with a mass fraction accounting for 2% of the monodisperse microspheres and a particle size of 100 nm, ultrasonic dispersion was carried out, the emulsion was sprayed onto a substrate and dried to obtain a non-iridescent structure colors anti-counterfeiting label with a triangle-pattern, which consisted of disordered optical structure. The anti-counterfeiting label was red, with carbon microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 15

To an emulsion containing monodisperse silver colloidal microspheres with a particle size of 250 nm and a mass fraction of 20%, was added ferroferric oxide microspheres (at a mass ratio of 1:1:1) with a mass fraction accounting for 30% of the monodisperse microspheres and a particle size of 10 μm and dopamine nanoparticles with a mass fraction accounting for 1% of the monodisperse microspheres and a particle size of 10 nm, ultrasonic dispersion was carried out, the emulsion was sprayed onto a substrate and dried to obtain a non-iridescent structure colors anti-counterfeiting label with a triangle-pattern, which consisted of disordered optical structure. The anti-counterfeiting label was red, with albumin microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 16

To an emulsion containing monodisperse polystyrene colloidal microspheres with a particle size of 250 nm and a mass fraction of 20%, was added albumin microspheres (at a mass ratio of 1:1:1) with a mass fraction accounting for 30% of the monodisperse microspheres and a particle size of 10 μm and melanin nanoparticles with a mass fraction accounting for 2% of the monodisperse microspheres and a particle size of 20 nm, ultrasonic dispersion was carried out, the emulsion was sprayed onto a substrate and dried to obtain a non-iridescent structure colors anti-counterfeiting label with a triangle-pattern, which consisted of disordered optical structure. The anti-counterfeiting label was red, with the albumin microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 17

To an emulsion containing monodisperse ferric sulfide colloidal microspheres with a particle size of 250 nm and a mass fraction of 20%, was added albumin microspheres (at a mass ratio of 1:1:1) with a mass fraction accounting for 30% of the monodisperse microspheres and a particle size of 10 μm and graphene nanosheets with a mass fraction accounting for 2% of the monodisperse microspheres and a particle size of 100 nm, ultrasonic dispersion was carried out, the emulsion was sprayed onto a substrate and dried to obtain a non-iridescent structure colors anti-counterfeiting label with a triangle-pattern, which consisted of disordered optical structure. The anti-counterfeiting label was red, with the albumin microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 18

To an emulsion containing monodisperse polystyrene colloidal microspheres with a particle size of 250 nm and a mass fraction of 20%, was added alumina (at a mass ratio of 1:1:1) with a mass fraction accounting for 30% of the monodisperse microspheres and a particle size of 10 μm and carbon nanotubes with a mass fraction accounting for 2% of the monodisperse microspheres and a particle size of 100 nm, ultrasonic dispersion was carried out, the emulsion was sprayed onto a substrate and dried to obtain a non-iridescent structure colors anti-counterfeiting label with a triangle-pattern, which consisted of disordered optical structure. The anti-counterfeiting label was red, with albumin microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

### Example 19

To an emulsion containing monodisperse gold colloidal microspheres with a particle size of 250 nm and a mass fraction of 20%, was added manganese dioxide (at a mass ratio of 1:1:1) with a mass fraction accounting for 30% of the monodisperse microspheres and a particle size of 10 μm and silver nanoparticles with a mass fraction accounting for 2% of the monodisperse microspheres and a particle size of 100 nm, ultrasonic dispersion was carried out, the emulsion was sprayed onto a substrate and dried to obtain a non-iridescent structure colors anti-counterfeiting label with a triangle-pattern, which consisted of disordered optical structure. The anti-counterfeiting label was red, with albumin microspheres distributed in the anti-counterfeiting label in a disordered and random manner. A reflection spectrum of the anti-counterfeiting label had a reflection peak at 630 nm. Images from the optical microscope were input into AI for learning and memorizing characteristics to form a database, the images from the optical microscope after changing the shooting environment were input into the database, and the result was judged to be true when a similarity value of the system was greater than 0.99.

What is claimed is:

1. A physically unclonable structural-color anti-counterfeiting label with artificial intelligence (AI) authentication, wherein the anti-counterfeiting label is formed by randomly doping micron-sized microspheres into disorderedly arranged monodisperse submicron-sized microspheres and coating onto a black substrate to form a pattern; alternatively, by randomly doping micron-sized microspheres and black nanoparticles into monodisperse submicron-sized microspheres and coating onto a substrate to form a pattern.

2. The anti-counterfeiting label according to claim 1, wherein the micron-sized microspheres are selected from one or a mixture of more of polymer microspheres, metal oxide microspheres and carbon spheres.

3. The anti-counterfeiting label according to claim 2, wherein the micron-sized microspheres are selected from one or a mixture of two or more of polystyrene microspheres, starch microspheres, albumin microspheres, gelatin microspheres, chitosan microspheres, silica microspheres, alumina microspheres, zinc oxide microspheres, ferroferric oxide microspheres, manganese dioxide microspheres, and titanium dioxide microspheres, with a size ranging from 1 μm to 50 μm.

4. The anti-counterfeiting label according to claim 1, wherein surfaces of the micron-sized microspheres are wrapped or partially covered by monodisperse submicron-sized particles.

5. The anti-counterfeiting label according to claim 1, wherein the monodisperse submicron-sized microspheres are selected from one of polymer colloidal microspheres, metal oxide colloidal microspheres, metal sulfides, metal colloidal microsphere and elementary substance colloidal microspheres.

6. The anti-counterfeiting label according to claim 5, wherein the monodisperse micron-sized microspheres are selected from one of styrene colloidal microspheres, polymethyl methacrylate colloidal microspheres, polystyrene-polymethyl methacrylate-polyacrylic acid colloidal microspheres, silica colloidal microspheres, titanium dioxide colloidal microspheres, ferric sulfide colloidal microspheres, gold colloidal microspheres, ferroferric oxide colloidal microspheres, copper oxide colloidal microspheres, sulfur colloidal microsphere, gold colloidal microspheres and silver colloidal microspheres, with a size ranging from 150 nm to 1000 nm.

7. The anti-counterfeiting label according to claim 1, wherein the black nanoparticles are selected from one of carbon black nanoparticles, ferroferric oxide nanoparticles, dopamine nanoparticles, melanin nanoparticles, graphene nanosheets, carbon nanotubes, and metal particles, with a size ranging from 5 nm to 100 nm, and a mass fraction accounting for 0.1%-2% of the monodisperse submicron microspheres.

8. The anti-counterfeiting label according to claim 1, wherein a mass fraction of the micron-sized microspheres accounts for 5%-50% of the monodisperse submicron microspheres.

9. The anti-counterfeiting label according to claim 1, wherein a spectral range corresponding to the structural colors ranges from 390 nm to 800 nm, covering the whole visible light region.

10. A method for verifying the anti-counterfeiting label according to claim 1, wherein firstly characteristics of disordered optical structures in images from optical microscopes are deep-learned and memorized by AI to form a genuine product database; secondly the label structures captured by the optical microscopes in a commodity circulation link are transmitted to the AI database for authentication by AI; and thirdly authenticity is verified according to similarity.
